(19) United States
(12) Patent Application Publication
(10) Pub. No.: US 2024/0368443 A1
(43) Pub. Date: Nov. 7, 2024

(54) METHOD FOR PREPARING A POLYURETHANE POLYMER

(71) Applicants: BOSTIK SA, COLOMBES (FR); UNIVERSITE CLAUDE BERNARD LYON 1, VILLEURBANNE CEDEX (FR); CENTRE NATIONAL DE LA RECHERCHE SCIENTIFIQUE, PARIS (FR); ECOLE SUPERIEURE DE CHIMIE PHYSIQUE ELECTRONIQUE DE LYON, VILLEURBANNE CEDEX (FR)

(72) Inventors: Guillaume MICHAUD, Lyon (FR); Stéphane FOUQUAY, COLOMBES (FR); Frédéric SIMON, VENETTE (FR); Francis PARDAL, VENETTE (FR); Priscilla ARNOULD, LYON (FR); Vincent MONTEIL, LYON (FR); Jean RAYNAUD, VILLEURBANNE (FR)

(21) Appl. No.: 18/267,799

(22) PCT Filed: Dec. 17, 2021
(86) PCT No.: PCT/FR2021/052376

§ 371 Date: Jun. 16, 2023

(30) Foreign Application Priority Data
Dec. 18, 2020 (FR) 2013762

(51) Int. Cl. C09J 175/08; C08G 18/12; C08G 18/16; C08G 18/18; C08G 18/24; C08G 18/40; C08G 18/42; C08G 18/48; C09J 5/00

(52) U.S. Cl. CPC C09J 175/08; C08G 18/12; C08G 18/165; C08G 18/1858; C08G 18/246; C08G 18/4018; C08G 18/4236; C08G 18/4829; C09J 5/00

(57) ABSTRACT

The invention relates to a method for preparing a polyurethane polymer, comprising: (A) contacting of at least one isophorone diisocyanate (IPDI) monomer with at least one first polyol in the presence of at least one first catalyst; (B) contacting of the urethane prepolymer with at least one second polyol in the presence of at least one second catalyst to form the polyurethane polymer, wherein the first catalyst is a guanidine-type catalyst and the second catalyst is an (organo) metallic catalyst or wherein the first catalyst is an (organo) metallic catalyst and the second catalyst is a guanidine-type catalyst.

The invention relates also to a two-component composition and to the use thereof as an adhesive for bonding two substrates together.

Lastly, the invention relates to an article comprising at least one layer obtained by crosslinking of said composition and to a method for preparing said article.

### FIELD OF THE INVENTION

The present invention relates to a method for preparing a polyurethane polymer by successively using a guanidine-type catalyst and an (organic)metallic catalyst. The present invention relates also to a two-component composition and to the uses of said composition. The invention relates also to articles produced with this composition and to the methods for producing said articles.

### TECHNICAL BACKGROUND

Flexible packagings intended for the packaging of a wide range of products, such as those manufactured for the food, cosmetics or detergent industries, generally consist of several thin layers (in the form of sheets or films) having a thickness of typically between 5 and 150 μm and composed of different materials such as paper, metal (for example aluminum) or even thermoplastic polymers. The corresponding multilayer film, the thickness of which can typically vary from 20 to 400 μm, makes it possible to combine the properties of the different individual layers of material and thus offer the consumer a suite of characteristics tailored to the flexible final packaging, for example: its visual appearance (especially that of the printed elements presenting the information relating to the packaged product and intended for the consumer), its effect as a barrier to atmospheric moisture or oxygen, contact with food without risk of toxicity or modification of the organoleptic properties of the packaged foods, chemical resistance for some products such as ketchup or liquid soap, and good resistance to high temperatures, for example if subjected to pasteurization or sterilization.

To form the final packaging, the multilayer film is generally shaped by heat-sealing at a temperature varying from approximately 120 to 250° C., this latter technique also being used for closing the packaging around the product intended for the consumer.

In industrial lamination processes, the various layers of material that make up the multilayer film are combined or assembled by lamination.

These methods use adhesives (or glues) and purpose-designed devices (or machines). The multilayer film thus obtained is often itself qualified by the term “laminated”.

These methods comprise firstly a step of coating the adhesive onto a first layer of material, that consists of the deposition of a continuous layer of glue of a controlled thickness generally greater than or equal to 1 μm and less than 25 μm, corresponding to an amount (or grammage) of glue that is likewise controlled and generally does not exceed 25 g/m². This coating step is followed by a step of laminating a second layer of material that is identical to or different from the first layer, consisting of the application under pressure of said second layer of material onto the first layer of material covered with the glue layer.

Polyurethane-based adhesives are commonly used for this type of application.

However, polyurethane-based compositions generally have the disadvantage of containing high residual contents of monomeric diisocyanate originating from the polyurethane synthesis reaction that could lead to a number of disadvantages, especially toxicity problems, especially in the case of aromatic diisocyanates. Specifically, the absence of labeling of polyurethanes means that residual diisocyanate contents must be as low as possible, and preferably less than 0.1% by weight. In order to obtain such low residual contents, production methods can be restrictive.

Moreover, polyurethane-based compositions are often prepared using organometallic catalysts, especially tin-based catalysts. However, some of these catalysts present high toxicological risks for humans and for the environment. It thus becomes necessary to avoid or reduce the use of toxic catalysts.

The article “Relative reactivity of isocyanate groups of isophorone diisocyanate. Unexpected high reactivity of the secondary isocyanate group” by H.-K. Ono et al. (Journal of Polymer Science, 1985, vol. 23, 509-515) concerns isophorone diisocyanate and describes a difference in reactivity between these two isocyanate groups. This article also describes the reaction of this diisocyanate with n-butanol in the presence of the catalyst DABCO and the dependence of the regioselectivity on the catalyst.

The article “Selectivity of isophorone diisocyanate in the urethane reaction influence of temperature, catalysis, and reaction partners” by R. Lomölder et al. (Journal of Coatings Technology, 1997, vol. 69, 51-57) concerns the synthesis of polyurethane prepolymer and describes the influence of the catalyst type, the temperature, and the type of —OH group on the selectivity of isophorone diisocyanate.

The article “Kinetics of urethane formation from isophorone diisocyanate: the catalyst and solvent effects” by S. V. Karpov et al. (Kinetics and Catalysis, 2016, vol. 57, 422-428) describes the influence of the catalyst and of the solvent on the kinetic parameters during the reaction between isophorone diisocyanate and various alcohols to form urethanes.

The articles “Cyclic guanidines as efficient organocatalysts for the synthesis of polyurethanes” by J. Alsarraf et al. (Macromolecules, 2012, vol. 45, 2249-2256) and “Latent catalysts based on guanidine templates for polyurethane synthesis” by J. Alsarraf et al. (Polymer Chemistry, 2013, vol. 4, 904-907) describe the use of guanidine-type catalysts for the synthesis of polyurethanes from polyisocyanates such as isophorone diisocyanate, toluene diisocyanate, and 4,4′-methylenebis (cyclohexyl isocyanate) and different polyols.

Document FR 2964106 A1 relates to the use of guanidine-type catalysts for the synthesis of polyurethanes.

Document WO 2017/171996 relates to an adhesive composition comprising a polyurethane composition and a catalyst that is the product of a reaction between an amidine-type compound, a guanidine-type compound, or an amine-type compound with carbon dioxide and water, an alcohol or a thiol.

There is therefore a real need to provide a method that makes it possible to obtain polyurethane polymers, particularly ones based on isophorone diisocyanate, while improving the kinetics of crosslinking for polymer formation and avoiding the use of toxic reagents. There is also a need to provide a polyurethane-based composition that makes it possible to improve the kinetics of crosslinking for polymer formation and is obtained while avoiding the use of toxic reagents.

### SUMMARY OF THE INVENTION

The invention relates firstly to a method for preparing a polyurethane polymer, comprising:
(A) contacting of at least one isophorone diisocyanate (IPDI) monomer with at least one first polyol in the presence of at least one first catalyst to form a urethane prepolymer;
(B) contacting of the urethane prepolymer with at least one second polyol in the presence of at least one second catalyst to form the polyurethane polymer;
   wherein:
the first catalyst is selected from a catalyst of the general formula (I) or a catalyst of the general formula (II):

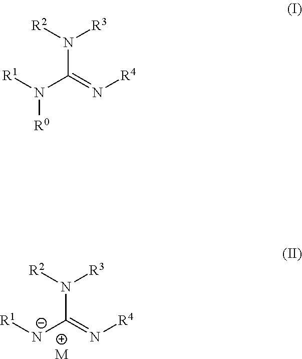

wherein:
   R⁰ is a group containing from 1 to 10 carbon atoms, selected from an alkyl group, either linear or branched, or a cycloalkyl or arylalkyl group,
   R¹, R², and R³ each independently represent a group containing from 1 to 10 carbon atoms, selected from an alkyl group, either linear or branched, or a cycloalkyl or arylalkyl group,
   R⁴ represents a hydrogen atom or a group containing from 1 to 10 carbon atoms, selected from an alkyl group, either linear or branched, or a cycloalkyl or arylalkyl group,
   at least two of R¹, R², R³, and R⁴ being optionally elements of a ring, and
   M⁺ represents a monovalent cation; and
the second catalyst is an (organic)metallic catalyst;
   or wherein:
the first catalyst is an (organo)metallic catalyst; and
the second catalyst is selected from a catalyst of the general formula (I) or a catalyst of the general formula (II).

According to some embodiments, the first catalyst is selected from a catalyst of the general formula (I) or a catalyst of the general formula (II) and the second catalyst is an (organic)metallic catalyst.

According to some embodiments, the first and/or the second polyol is selected from polyether polyols, polyester polyols, and mixtures thereof, and preferably the first and/or the second polyol comprises a polypropylene glycol.

According to some embodiments, the second polyol is the same as the first polyol.

According to some embodiments, M⁺ represents a Na⁺ cation.

According to some embodiments, R₀ is selected from a methyl group or a benzyl group.

According to some embodiments, R¹ and R² or R¹ and R⁴ are elements of a ring.

According to some embodiments, R¹ and R² are elements of a first ring and R³ and R⁴ are elements of a second ring.

According to some embodiments, the (organo)metallic catalyst is selected from a tin catalyst, a zinc catalyst, a bismuth catalyst, a titanium catalyst, an iron catalyst, a copper catalyst, a zirconium catalyst, an aluminum catalyst, and combinations thereof, and the (organo)metallic catalyst is preferably selected from a zinc catalyst, a bismuth catalyst, a titanium catalyst, an iron catalyst, a copper catalyst, an aluminum catalyst, and a zirconium catalyst.

According to some embodiments, the step of contacting at least one isophorone diisocyanate (IPDI) monomer with at least one first polyol, the NCO/OH molar ratio is between 1.5 and 5, preferably between 1.5 and 4, preferably between 1.5 and 3, and more preferably between 1.5 and 2.

The invention relates also to a two-component composition for preparing a polyurethane polymer according to the above method, the composition comprising:
an NCO component comprising the urethane prepolymer prepared by step (A) of the method;
and an OH component comprising at least a second polyol and the second catalyst.

According to some embodiments, the NCO component also comprises one or more additives selected from plasticizers, solvents, pigments, adhesion promoters, moisture absorbers, UV stabilizers (or antioxidants), fluorescent materials, rheological additives, and mixtures thereof.

According to some embodiments, the NCO/OH molar ratio of the NCO component to the OH component is from 1.5 to 2.5, and preferably from 1.7 to 2.0.

The invention relates also to the use of said composition as an adhesive for bonding two substrates together.

The invention relates also to an article comprising at least one layer obtained by crosslinking of said composition.

The invention relates also to a method for preparing said article, comprising:
mixing of the NCO component with the OH component of the composition;
coating of this mixture onto the surface of a substrate; and
contacting of this surface with the surface of an additional substrate.

The present invention makes it possible to meet the need expressed above. It more particularly provides a method that makes it possible to obtain polyurethane polymers, in particular ones based on isophorone diisocyanate, while improving the kinetics of crosslinking for polymer formation and avoiding the use of toxic reagents. The invention also provides a polyurethane-based composition that makes it possible to improve the kinetics of crosslinking for polymer formation and is obtained while avoiding the use of toxic reagents.

This is accomplished by the method of the present invention. More particularly, this method comprises two distinct steps: a first step of forming of a urethane prepolymer using a first catalyst and a second step of forming of the polyurethane polymer using a second catalyst. Either the first or the second catalyst is a guanidine-type catalyst and the other of said catalysts is an (organo)metallic catalyst. The use of one or the other (catalyst of the guanidine type or of the (organo)metallic type) as the first catalyst makes it possible to improve the kinetics of crosslinking. It also makes it possible to control the regioselectivity of the reaction. Specifically, isophorone diisocyanate being an unsymmetrical diisocyanate containing a first isocyanate group attached to a primary carbon atom (C1) and a second isocyanate group attached to a secondary carbon atom (C2), the use of a first catalyst of the guanidine type or of the (organo)metallic type makes it possible to increase the regioselectivity of the reaction, that is to say in the first step the diol reacts preferentially either with the first or with the second isocyanate group, this selectivity depending on the first catalyst. More particularly, the use of a guanidine-type catalyst as first catalyst makes it possible to favor the reaction of isocyanate groups attached to a primary carbon atom (C1), whereas the use of an (organic)metallic catalyst makes it possible to favor the reaction of isocyanate groups attached to a secondary carbon atom (C2). The use thereafter of a second catalyst (of the guanidine type or of the (organic)metallic type, but different from the first catalyst) having a reverse regioselectivity permits the reaction of the diol with the other of the first or second isocyanate groups of the urethane prepolymer to form the polyurethane polymer.

Advantageously, the use of the guanidine-type catalyst as first catalyst also makes it possible to control the amount of residual monomer.

### DETAILED DESCRIPTION

The invention is now described in more detail and without limitation in the description that follows.

The invention relates to a method for preparing a polyurethane polymer.

This method comprises a first step of forming of a urethane prepolymer and a second step of formulating of the polyurethane adhesive. A “urethane prepolymer” is understood as meaning an intermediate in the synthesis of a polyurethane that corresponds to a polymer containing in its main chain at least two urethane groups and at least two reactive isocyanate functions which enable it to undergo at least one polyaddition reaction.

In what follows, the first catalyst is a guanidine-type catalyst of the general formula (I) or (II) and the second catalyst is an (organic)metallic catalyst.

However, the whole of the description similarly applies by analogy to the case where the first catalyst is an (organic)metallic catalyst and the second catalyst is a guanidine-type catalyst of the general formula (I) or (II).

The term “(organic)metallic” encompasses metallic and organometallic catalysts.

### Step 1—Formation of the Urethane Prepolymer

The first step of the method according to the invention is carried out by contacting at least one isophorone diisocyanate (IPDI) monomer with at least one first polyol in the presence of a first guanidine-type catalyst, i.e. one containing a structure composed of three nitrogen atoms bonded to a carbon atom, one of the nitrogen atoms being bonded to the carbon atom with a double bond. The guanidine-type catalyst has the general formula (I) or the general formula (II).

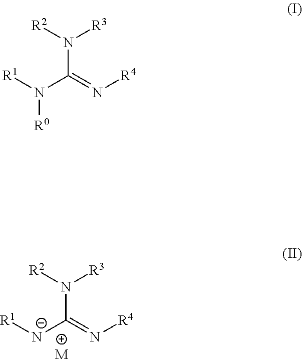

R⁰, R¹, R², and R³ are different from a hydrogen atom. In other words, at least two of the nitrogen atoms present in the catalyst are not protonated. This makes it possible to obtain high regioselectivity (as explained below) and therefore to reduce the residual monomer content.

In formula (I), R⁰ is a group containing from 1 to 10 carbon atoms and preferably a group containing from 1 to 7 carbon atoms.

R⁰ may be an alkyl group, either linear or branched, or a cycloalkyl or arylalkyl group. For example, it may be a methyl group, an ethyl group, an n-propyl group, an isopropyl group, a cyclopropyl group, a tert-butyl group, an isobutyl group, an n-butyl group, a sec-butyl, a cyclobutyl group, a cyclopentyl group, a cyclohexyl group, an n-hexyl group, an n-octyl group, a 2-ethylhexyl group, an n-decyl group, an alkyl group substituted by an aryl group (arylalkyl group), such as a benzyl group, an alkyl group substituted by an ester group, an alkyl group substituted by a tertiary amino group or an alkyl group substituted by an alkyldialkoxysilane or alkyltrialkoxysilane group.

According to some embodiments R⁰ is a methyl, ethyl, n-propyl, n-butyl, isobutyl, n-pentyl or n-hexyl group.

According to other embodiments R⁰ is a benzyl group.

In formula (II), M⁺ represents a monovalent cation, preferably selected from Li⁺, Na⁺, and K⁺.

More preferably, M⁺ is an Na⁺ cation.

R¹, R², and R³ each independently represent a group containing from 1 to 10 carbon atoms.

Thus, R¹, R², and R³ may each be independently selected from an alkyl group, either linear or branched, or a cycloalkyl or arylalkyl group. For example, R¹, R², and R³ may each be independently selected from a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group or an alkyl group substituted by an aryl group (arylalkyl group), such as an alkyl phenyl.

R⁴ may be a hydrogen atom or a group containing from 1 to 10 carbon atoms. It may be an alkyl group, either linear or branched, or a cycloalkyl, arylalkyl or aryl group. For example, R⁴ may be selected from a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group (arylalkyl group), such as an alkyl phenyl, or a phenyl group that is unsubstituted or substituted by one or more groups such as an alkyl (=alkylaryl group) or cycloalkyl group, an alkoxy group, a halogen, a nitro group or a carbonyl group.

According to some preferred embodiments, R¹, R², R³, and R⁴ may be alkyl groups containing from 1 to 7 carbon atoms. For example, R¹, R², and R³ may be methyl groups, and R⁴ may be a methyl, isopropyl, cyclohexyl or tert-butyl group.

According to some preferred embodiments, R¹, R², and R³ may be alkyl groups containing from 1 to 7 carbon atoms, for example methyl groups, and R⁴ may be an aryl group, for example phenyl.

Alternatively and preferably, at least two of R¹, R², R³, and R⁴ are elements of a ring. This means there is a covalent bond between an atom of one of the groups and an atom of one of the other groups.

Thus, according to some embodiments, R¹ and R² or R³ and R⁴ may be elements of a ring. This makes it possible to obtain monocyclic catalysts such as those of the general formula (III) or (IV):

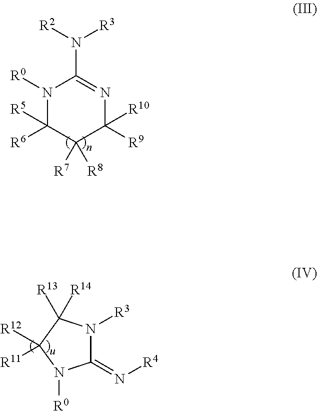

In the case of the catalyst of the formula (III), the groups R¹ and R⁴ form a ring, whereas in the case of the catalyst of the formula (IV) it is the groups R¹ and R² that form a ring.

In these cases of the catalyst of the formula (III), n may be a number from 0 to 3, preferably from 0 to 1, and more preferably n may be 1. Thus, it may comprise a five-atom ring, a six-atom ring, a seven-atom ring or an eight atom ring, preferably a five-atom or six-atom ring and more preferably a six-atom ring.

In the case of the catalyst of the formula (IV), u may be a number from 1 to 4, preferably from 1 to 2, and more preferably u may be 1. Thus, it may comprise a five-atom ring, a six-atom ring, a seven-atom ring or an eight-atom ring.

In the catalysts of the formula (III) and (IV), R⁰, R², R³, and R⁴ are as defined for formulas (I) and (II).

R⁵, R⁶, R⁷, R⁸, R⁹, R¹⁰, R¹¹, R¹², R¹³, and R¹⁴ may be selected, each independently of one another, from a hydrogen atom or a group containing from 1 to 10 carbon atoms and preferably from 1 to 7 carbon atoms.

Thus, R⁵, R⁶, R⁷, R⁸, R⁹, R¹⁰, R¹¹, R¹², R¹³, and R¹⁴ may each be independently selected from a hydrogen atom, an alkyl group, either linear or branched, or a cycloalkyl, arylalkyl or aryl group. For example, R⁵, R⁶, R⁷, R⁸, R⁹, R¹⁰, R¹¹, R¹², R¹³, and R¹⁴ may each be independently selected from a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group (arylalkyl group), such as an alkyl phenyl, a phenyl group that is unsubstituted or substituted by one or more groups such as an alkyl (=alkylaryl group) or cycloalkyl group, an alkoxy group, a halogen, a nitro group, or a carbonyl group.

According to some embodiments, at least one of R⁵, R⁶, R⁷, R⁸, R⁹, R¹⁰, R¹¹, R¹², R¹³, and R¹⁴, preferably at least two of R⁵, R⁶, R⁷, R⁸, R⁹, R¹⁰, R¹¹, R¹², R¹³, and R¹⁴, preferably at least three of R⁵, R⁶, R⁷, R⁸, R⁹, R¹⁰, R¹¹, R¹², R¹³, and R¹⁴, more preferably at least four of R⁵, R⁶, R⁷, R⁸, R⁹, R¹⁰, R¹¹, R¹², R¹³, and R¹⁴, preferably at least five of R⁵, R⁶, R⁷, R⁸, R⁹, R¹⁰, R¹¹, R¹², R¹³, and R¹⁴, and even more preferably all of R⁵, R⁶, R⁷, R⁸, R⁹, R¹⁰, R¹¹, R¹², R¹³, and R¹⁴ are a hydrogen atom.

Although not illustrated in formulas (III) and (IV) above, it is also possible for the —N—R⁰ group to be replaced by a —N⁻M⁺ group in which M⁺ is as described above.

According to other preferred embodiments, R¹ and R² are elements of a first ring and R³ and R⁴ are elements of a second ring. Such catalysts are bicyclic. Bicyclic catalysts may in particular be of the general formula (V):

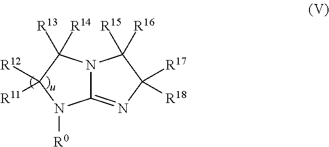

In the case of the catalyst of the formula (V), the groups R¹ and R² form a first ring and the groups R³ and R⁴ form a second ring.

In this case, t may be a number from 1 to 4, preferably from 1 to 3, and more preferably t may be 1 or 2. Thus, it may comprise a five-atom ring, a six-atom ring, a seven-atom ring or an eight-atom ring.

In addition, u is as defined above.

According to some embodiments, t and u are different.

According to preferred embodiments, t and u are identical, for example, n and u are equal to 1 or n and u are equal to 2.

R¹¹, R¹², R¹³, R¹⁴, R¹⁵, R¹⁶, R¹⁷, and R¹⁸ may be selected, each independently of one another, from a hydrogen atom or a group containing from 1 to 10 carbon atoms and preferably from 1 to 7 carbon atoms.

Thus, R¹¹, R¹², R¹³, R¹⁴, R¹⁵, R¹⁶, R¹⁷, and R¹⁸ may each be independently selected from a hydrogen atom, an alkyl group, either linear or branched, or a cycloalkyl, arylalkyl or aryl group. For example, R¹¹, R¹², R¹³, R¹⁴, R¹⁵, R¹⁶, R¹⁷, and R¹⁸ may each be independently selected from a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group (arylalkyl group), such as an alkyl phenyl, a phenyl group that is unsubstituted or substituted by one or more groups such as an alkyl (=alkylaryl group) or cycloalkyl group, an alkoxy group, a halogen, a nitro group, or a carbonyl group.

According to some embodiments, at least one of R¹¹, R¹², R¹³, R¹⁴, R¹⁵, R¹⁶, R¹⁷, and R¹⁸, preferably at least two of R¹¹, R¹², R¹³, R¹⁴, R¹⁵, R¹⁶, R¹⁷, and R¹⁸, preferably at least three of R¹¹, R¹², R¹³, R¹⁴, R¹⁵, R¹⁶, R¹⁷, and R¹⁸, more preferably at least four of R¹¹, R¹², R¹³, R¹⁴, R¹⁵, R¹⁶, R¹⁷, and R¹⁸, preferably at least five of R¹¹, R¹², R¹³, R¹⁴, R¹⁵, R¹⁶, R¹⁷, and R¹⁸, preferably at least six of R¹¹, R¹², R¹³, R¹⁴, R¹⁵, R¹⁶, R¹⁷, and R¹⁸, preferably at least seven of R¹¹, R¹², R¹³, R¹⁴, R¹⁵, R¹⁶, R¹⁷, and R¹⁸, and even more preferably all of R¹¹, R¹², R¹³, R¹⁴, R¹⁵, R¹⁶, R¹⁷, and R¹⁸ are a hydrogen atom.

According to some embodiments, in the first catalyst of the formula (V), R¹¹, R¹², R¹³, R¹⁴, R¹⁵, R¹⁶, R¹⁷, and R¹⁸ are a hydrogen atom and t and u are equal to 1, or t and u are equal to 2, or t is equal to 1 and u is equal to 2, or t is equal to 2 and u is equal to 1, or t is equal to 2 and u is equal to 3, or t is equal to 2 and u is equal to 4, or t is equal to 3 and u is equal to 2, or t is equal to 4 and u is equal to 2.

Although not illustrated in formula (V) above, it is also possible for the —N—R⁰ group to be replaced by a —N⁻M⁺ in which M⁺ is as described above.

According to some preferred embodiments, the first catalyst may be selected from 7-methyl-1,5,7-triazabicyclo[4.4.0]dec-5-ene (MTBD), benzylated 1,5,7-triazabicyclo[4.4.0]dec-5-ene (Bn-TBD), 1,5,7-triazabicyclo[4.4.0]dec-5-ene sodium (TBD⁻Na⁺), N-methyl-1,4,6-triazabicyclo[3.3.0]oct-4-ene (MTBO), 1,4,6-triazabicyclo[3.3.0]oct-4-ene sodium (TBO⁻Na⁺), pentamethylguanidine (PTMG), tetramethylguanidine (TMG), 2-tert-butyl-1,1,3,3-tetramethylguanidine (BTMG), N,N,N′,N′-tetramethyl-N″-phenylguanidine (Ph-TMG), 1,3-dimethyl-2-imidazolidinimine, 1,3-dimethyl-2-methyliminoimidazolidine, and combinations thereof.

According to some preferred embodiments, just one first catalyst is contacted with the isophorone diisocyanate and the polyol(s).

According to other embodiments, a mixture of two or more first catalysts as described above (for example two, three or four first catalysts) is contacted with the isophorone diisocyanate and the polyol(s).

Preferably, no other catalyst is contacted with the reactants in this step, and in particular the second catalyst described in more detail below is not contacted with the reactants during this step.

The first catalyst (or the different first catalysts if more than one first catalyst is present during this step) may be present in a content of from 50 to 10 000 ppm, preferably 100 to 5000 ppm, preferably 200 to 1000 ppm, and preferably from 300 to 800 ppm, relative to the weight of the mixture of isocyanate (isophorone diisocyanate) and polyol(s).

The polyol(s) may be selected from polyether polyols and polyester polyols and mixtures thereof.

According to some embodiments, one polyol is contacted with the isophorone diisocyanate.

According to other embodiments, two or more polyols (for example two, three or four polyols) are contacted with the isophorone diisocyanate.

The polyol(s) that can be used may have a number-average molecular weight ranging from 200 g/mol to 10 000 g/mol, preferably from 400 to 5000 g/mol, preferably from 400 to 3000 g/mol.

The number-average molecular weight of the polyols can be calculated from the hydroxyl value (OH value) expressed in mg KOH/g and the functionality of the polyol or determined by methods well known to those skilled in the art, by example by size-exclusion chromatography (SEC) with a polystyrene standard.

The polyol(s) may have a hydroxyl functionality ranging from 2 to 6, preferably 2 to 3. In the context of the invention and unless otherwise stated, the hydroxyl functionality of a polyol is the average number of hydroxyl functions per mole of polyol.

When the polyol(s) is/are one or more polyester polyols, it/they may have a number-average molecular weight ranging from 8000 g/mol to 15 000 g/mol, preferably from 800 to 10 000 g/mol, preferably from 800 to 5000 g/mol, and preferably from 800 to 3000 g/mol.

Examples of polyester polyols include:
polyester polyols of natural origin such as castor oil;
polyester polyols resulting from the condensation: of one or more aliphatic (linear, branched or cyclic) or aromatic polyols such as ethanediol, propane-1,2-diol, propane-1,3-diol, glycerol, trimethylolpropane, hexane-1,6-diol, hexane-1,2,6-triol, butenediol, sucrose, glucose, sorbitol, pentaerythritol, mannitol, triethanolamine, N-methyldiethanolamine, and mixtures thereof with one or more polycarboxylic acids or ester or anhydride derivatives, such as hexane-1,6-dioic acid, dodecanedioic acid, azelaic acid, sebacic acid, adipic acid, octadecane-1,18-dioic acid, phthalic acid, succinic acid, and mixtures of these acids, an unsaturated anhydride, such as maleic or phthalic anhydride, or a lactone, such as caprolactone.

The polyester polyols mentioned above can be prepared by conventional means and are for the most part commercially available.

Examples of polyester polyols include the following products having a hydroxyl functionality equal to 2:
Dekatol® 3008 (sold by Bostik), which is an aliphatic polyester diol having a number-average molecular weight of between 425 and 455 g/mol and a hydroxyl value (OH value) of between 370 and 396 mg KOH/g,
Realkyd XTR 10410 (sold by Arkema), which is a polyester polyol having a number-average molecular weight of between 967 and 1038 g/mol and a hydroxyl value (OH value) of between 108 and 116 mg KOH/g,
Realkyd XTR 09431 (sold by Arkema), which is a polyester polyol having a number-average molecular weight of between 794 and 843 g/mol and a hydroxyl value (OH value) of between 133 and 143 mg KOH/g,
Realkyd XTR 10W30 (sold by Arkema), which is a polyester polyol having a number-average molecular weight of between 967 and 1038 g/mol and a hydroxyl value (OH value) of between 108 and 116 mg KOH/g,

According to some embodiments, the polyester polyol is selected from: a castor polyol estolide; castor oil; a polyester polyol resulting from the condensation of ethylene glycol, propylene glycol, propane-1,3-diol, and/or hexane-1,6-diol with adipic acid and/or the various isomers of phthalic acid; and mixtures thereof.

When the polyol(s) is/are one or more polyether polyols, it/they may have a number-average molecular weight ranging from 200 to 10 000 g/mol, preferably from 400 to 10 000 g/mol, preferably from 400 to 5000 g/mol, and preferably from 400 to 3000 g/mol.

Preferably, the polyether polyol(s) has/have a hydroxyl functionality ranging from 2 to 3.

In the context of the invention, polyether polyols are preferably selected from polyoxyalkylene polyols, the alkylene part of which is linear or branched and contains from 1 to 4 carbon atoms, preferably from 2 to 3 carbon atoms.

More preferably, the polyether polyol(s) may be selected from polyoxyalkylene diols or polyoxyalkylene triols, and better still polyoxyalkylene diols, the alkylene part of which is linear or branched and contains from 1 to 4 carbon atoms, preferably from 2 to 3 carbon atoms.

Examples of polyoxyalkylene diols or triols that may be used according to the invention include:
polyoxypropylene diols or triols (also referred to as polypropylene glycol (PPG) diols or triols) having a number-average molecular weight ranging from 200 g/mol to 10 000 g/mol and preferably ranging from 400 g/mol to 12 000 g/mol,
polyoxyethylene diols or triols (also referred to as polyethylene glycol (PEG) diols or triols) having a number-average molecular weight ranging from 200 g/mol to 10 000 g/mol and preferably ranging from 400 g/mol to 10 000 g/mol,
polyoxybutylene glycols (also referred to as polybutylene glycol (PBG) diols or triols) having a number-average molecular weight ranging from 200 g/mol to 10 000 g/mol,
PPG/PEG/PBG diol or triol copolymers or terpolymers having a number-average molecular weight ranging from 200 g/mol to 10 000 g/mol,
polytetrahydrofuran (polyTHF) diols or triols having a number-average molecular weight ranging from 200 g/mol to 10 000 g/mol,
polytetramethylene glycols (PTMG) having a number-average molecular weight ranging from 200 g/mol to 10 000 g/mol,
and mixtures thereof.

Preferably, the polyether polyols are selected from polyoxypropylene diols or triols and polyoxyethylene diols or triols. More preferably, the polyether polyols are selected from polyethylene glycols and polypropylene glycols, preferably from polypropylene glycols. The polyether polyols mentioned above can be prepared by conventional means and are widely available commercially. They can for example be obtained by polymerization of the corresponding alkylene oxide in the presence of a catalyst based on a double metal cyanide complex (DMC).

More preferably, the first polyol may be a mixture of a diol and a triol, for example a polyoxypropylene diol and a polyoxypropylene triol.

Examples of polyether diols include the polyoxypropylene diols sold under the Acclaim® name by Covestro, such as Acclaim® 8200, which has a number-average molecular weight close to 8057 g/mol, and Acclaim® 4200, which has a number-average molecular weight close to 4020 g/mol, or else the polyoxypropylene diols sold under the Voranol™ name by Dow, such as Voranol 1010L, which has a number-average molecular weight close to 1000 g/mol, and Voranol 2000 L, which has a number-average molecular weight close to 2004 g/mol.

Examples of polyether triols include the polyoxypropylene triol sold under the name Voranol® CP3355 by Dow, which has a number-average molecular weight close to 3554 g/mol, and the polyoxypropylene triol Voranol® CP450, which has an average molecular weight of between 425 and 455 g/mol.

According to preferred embodiments, the NCO/OH molar ratio in this step is between 1.5 and 5.5, preferably between 1.5 and 4, preferably between 1.5 and 3, and more preferably between 1.5 and 2. For example, this molar ratio may be from 1.5 to 2; or from 2 to 2.5; or from 2.5 to 3; or from 3 to 3.5; or from 3.5 to 4; or from 4 to 4.5; or from 4.5 to 5; or from 5 to 5.5. In the context of the invention and unless otherwise stated, the NCO/OH molar ratio corresponds to the molar ratio of the number of isocyanate groups (NCO) to the number of hydroxyl groups (OH) present respectively in the polyisocyanate(s) and the polyol(s) used. Specifically, a low NCO/OH molar ratio makes it possible to reduce the amount of residual monomer.

During the step of contacting at least one isophorone diisocyanate monomer with at least one polyol in the presence of a first catalyst, the hydroxyl groups present on the first polyol can react (in the presence of the first catalyst) with the isocyanate termini of the isophorone diisocyanate to form the urethane prepolymer. More particularly, as described above, the isophorone diisocyanate is an unsymmetrical diisocyanate containing a first isocyanate group attached to a primary carbon atom and a second isocyanate group attached to a secondary carbon atom. The presence of the first catalyst makes it possible to increase the regioselectivity of the reaction. In other words, the first catalyst makes it possible to “direct” the reaction of the hydroxyl groups with either the first or second isocyanate group. This also makes it possible to control the amount of residual monomer in addition to the selection of the NCO/OH ratio as previously indicated.

The regioselectivity of this reaction is calculated according to the method detailed below. Thus, when reacting an amount x of isophorone diisocyanate with an amount y of a diol, three different products may be obtained as illustrated in the reaction scheme below. The amounts thereof, y, z, and t, and the amount x′ of residual monomer, depend on the regioselectivity of the reaction. In other words, the diol can react with the isocyanate group attached to a primary carbon atom or with the isocyanate group attached to a secondary carbon atom. In the reaction scheme below, the carbon atoms of the carbamate functions —NH—(C═O)—O— of the chain are numbered C1′ for the primary carbon atoms and C2′ for the secondary carbon atoms and the carbon atoms of the carbamate functions —NH—(C═O)—O— chain termini are numbered C1 for the primary carbon atoms and C2 for the secondary carbon atoms.

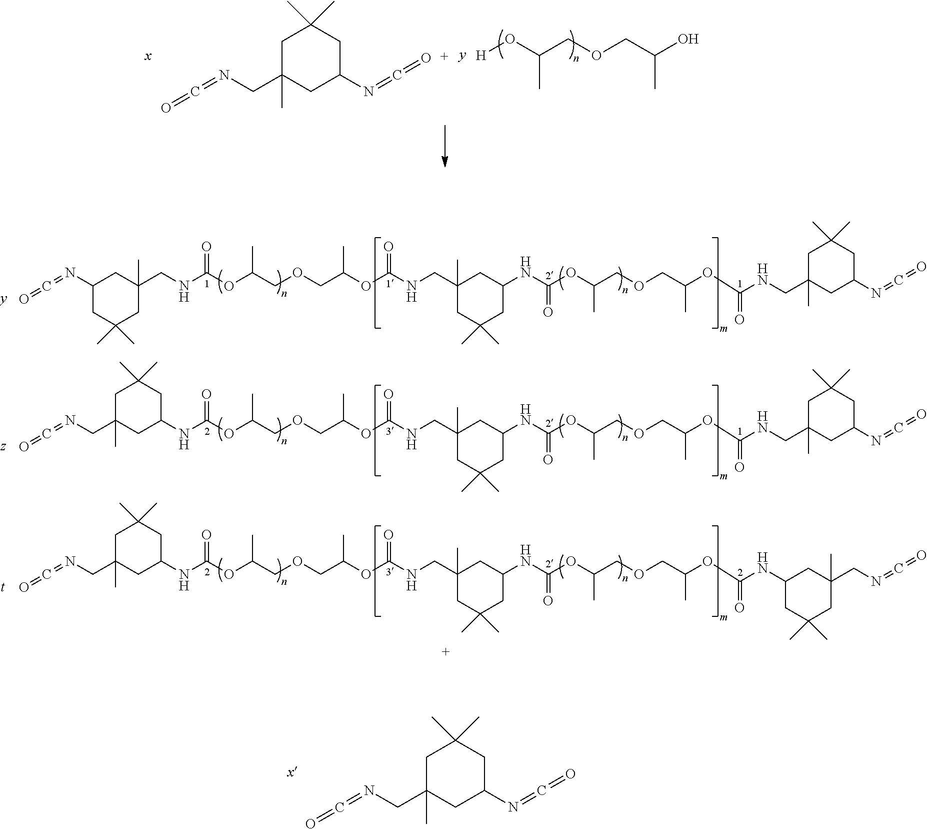

To determine the relative reactivity of the isocyanate groups of isophorone diisocyanate, the following molar equivalent ratio was determined by ¹³C-NMR spectroscopy (300 MHz 1H, conditions: pulse angle: 30, relaxation time: 2 s, number of scans>1000):

$$\\ r = \frac{( C 1 + C {1}^{′} ) - ( C 2 + C {2}^{′} )}{( C 1 + C {1}^{′} ) + ( C 2 + C {2}^{′} )}$$

The molar equivalent ratio can be simplified in the numerator in the knowledge that C1′=C2′ in the chain:

$$\\ r = \frac{C 1 - C 2}{( C 1 + C {1}^{′} ) + ( C 2 + C {2}^{′} )}$$

The value r (regioselectivity) can vary only between −2/(C1+C1′)+(C2+C2′) and +2/(C1+C1′)+(C2+C2′), the value 2 in the numerator corresponding to the two carbamate functions of the chain termini per mole of prepolymer.

Based on this method, the use of the first catalyst makes it possible to obtain the prepolymer with a regioselectivity (r) greater than or equal to 0.10, preferably greater than or equal to 0.25, and more preferably greater than or equal at 0.3. For example, it can have a value of from 0.10 to 0.15; or from 0.15 to 0.20; or from 0.20 to 0.25; or from 0.25 to 0.30; or from 0.30 to 0.35; or from 0.35 to 0.40; or from 0.40 to 0.45; or from 0.45 to 0.50; or from 0.50 to 0.55; or from 0.55 to 0.60; or be greater than 0.60.

In particular, for an NCO/OH ratio in the first step of 4.5 to 5.5, for example close to 5, the regioselectivity is advantageously greater than or equal to 0.25, or 0.30, or 0.35, or 0.40, or 0.45. For an NCO/OH ratio in the first step of 1 to 2, for example from 1.5 to 1.9 and even more preferably of approximately 1.5, the regioselectivity is advantageously greater than or equal to 0.10, or 0.15, or 0.20, or 0.25 and preferably greater than or equal to 0.30.

This regioselectivity is determined by ¹³C-NMR spectroscopy with acquisition conditions that permit the quantitative integration of peaks C1, C1′, C2, and C2′ (300 MHz ¹H, conditions: pulse angle: 30, relaxation time: 2 s, number of scans>1000).

During this step, one or more additional compounds may be present in addition to the isophorone diisocyanate, the polyol(s), and the guanidine-type catalyst. For example, such an additional compound may be a solvent, preferably selected from ethyl acetate, acetone, and methyl ethyl ketone.

This step may be carried out at a temperature ranging from 30 to 120° C., preferably from 40 to 100° C., and preferably at a temperature ranging from 50 to 90° C.

In addition, this step may be carried out for a period of 2 to 10 hours, preferably 2 to 4 hours, with the guanidine-type catalysts of the invention.

The prepolymer obtained at the end of this step may have a number-average molecular weight of 800 to 20 000 g/mol, preferably of 1000 to 10 000 g/mol, and preferably 2000 to 8000 g/mol. Molecular weight is measured by size-exclusion chromatography using polystyrene as calibration standard.

In addition, the urethane prepolymer may have a percentage by weight of NCO groups ranging from 2 to 20%, preferably from 2 to 10%, and more preferably from 2 to 6%, relative to the total weight of the urethane prepolymer.

For NCO/OH molar ratios of less than 2, the urethane prepolymer may have a residual monomer content of less than or equal to 5%, and preferably less than or equal to 3%.

This urethane prepolymer may also have a Brookfield viscosity at 23° C., measured at day+1, ranging from 500 to 400 000 mPa·s, preferably ranging from 500 to 300 000 mPa·s, preferably ranging from 500 to 200 000 mPa·s, preferably ranging from 500 to 100 000 mPa·s, preferably ranging from 500 to 50 000 mPa·s, preferably ranging from 500 to 25 000 mPa·s, preferably, preferably ranging from 500 to 12 000 mPa·s, preferably ranging from 500 to 6000 mPa·s, and preferably ranging from 500 to 3000 mPa·s, depending on the NCO/OH ratio used and the nature of the polyols used.

### Step 2—Formation of the Polyurethane Polymer

The second step of the method according to the invention is carried out by contacting the urethane prepolymer with at least one second polyol to form the polyurethane polymer. This step is carried out in the presence of a second catalyst.

The second polyol(s) may be selected from the same polyols as the first polyol(s) previously described.

According to some embodiments, the second polyol(s) is/are identical to, different from, or different in part from the first polyol(s).

According to some embodiments, just one second polyol is contacted with the urethane prepolymer.

According to other embodiments, more than one second polyol (for example two or three second polyols) are contacted with the urethane prepolymer.

According to preferred embodiments, the NCO/OH molar ratio in this second step may be from 1.3 to 3, preferably from 1.5 to 2.

The second catalyst is a metallic catalyst. A “metal catalyst” is understood as meaning a catalyst containing at least one metal atom.

According to preferred embodiments, the metal may be selected from tin, zinc, bismuth, aluminum, titanium, iron, copper, and zirconium.

Preferably, the second catalyst is selected from a zinc catalyst, a bismuth catalyst, a titanium catalyst, an iron catalyst, a copper catalyst, a zirconium catalyst, an aluminum catalyst, and combinations thereof. In other words, tin is preferably absent in the second catalyst.

The second catalyst may be a metal carboxylate.

The carboxylates may be ones in which the carboxylic acid contains from 2 to 20 carbon atoms, preferably from 4 to 14 carbon atoms. Examples of carboxylic acids include: acetic acid, butyric acid, isobutyric acid, caproic acid, caprylic acid, 2-ethylhexanoic acid, capric acid, lauric acid, myristic acid, palmitic acid, stearic acid, isostearic acid, abietic acid, neodecanoic acid, 2,2,3,5-tetramethylhexanoic acid, 2,4-dimethyl-2-isopropylpentanoic acid, 2,5-dimethyl-2-ethylhexanoic acid, 2,2-dimethyloctanoic acid, 2,2-diethylhexanoic acid, and arachidic acid.

The carboxylates may be monocarboxylates, dicarboxylates, tricarboxylates, or mixtures thereof.

Alternatively, the second catalyst may be a metal coordination complex, that is to say a metal complexed with one or more organic ligands. This type of catalyst may be selected from, for example, zinc acetylacetonate, titanium acetylacetonate (commercially available for example under the name Tyzor® AA75 Dorf Ketal), titanium tetraacetylacetonate, aluminum from trisacetylacetonate, aluminum chelates such as the monoacetylacetonate bis (ethylacetoacetate) (commercially available for example under the name K-KAT® 5218 from King Industries), zirconium tetraacetylacetonate, diisopropoxybis (ethylacetonato) titanium, zirconium acetylacetonate, copper acetylacetonate, and mixtures thereof.

More alternatively, the second catalyst may be selected from, for example, dioctyltin dicarboxylates such as dioctyltin diacetate, dioctyltin diethylhexanoate, dioctyltin dineodecanoate (available for example under the name TIB KAT® 223 from TIB Chemicals), dioctyltin dilaurate (DOTL) (available for example under the name TIB KAT® 216 from TIB Chemicals), dibutyltin dioleate, dibutyltin benzylmaleate, and mixtures thereof.

According to preferred embodiments, the second catalyst may be selected from diisopropoxybis (ethylacetoacetato) titanium, zinc neodecanoate, titanium neodecanoate, iron acetylacetonate, zirconium acetylacetonate, copper acetylacetonate, and mixtures thereof.

According to some embodiments, just one second catalyst is contacted with the urethane prepolymer and the second polyol(s).

According to other embodiments, a mixture of two or more second catalysts (for example two) is contacted with the urethane prepolymer and the second polyol(s).

The second catalyst may be present in a content of from 100 to 2000 ppm, and preferably from 200 to 800 ppm, relative to the weight of the OH component.

During this step, one or more additional compounds may be present in addition to the urethane prepolymer, the second polyol(s), and the metal catalyst(s). For example, such an additional compound may be a solvent, preferably selected from ethyl acetate, acetone, and methyl ethyl ketone.

The contacting of the urethane prepolymer with the second polyol(s) and the second catalyst(s) during this second step may be carried out by adding the second polyol(s) and the second catalyst(s) to the mixture resulting from the first step and comprising the urethane prepolymer.

This second step may be carried out at a temperature of from 15 to 60° C. and preferably at a temperature of from 23 to 50° C.

### Two-Component Composition

The invention relates also to a two-component composition comprising an NCO component and an OH component.

The NCO component of the composition comprises the urethane prepolymer prepared according to the first step of the method described above.

According to preferred embodiments, the NCO component corresponds to the mixture obtained after contacting the isophorone diisocyanate with the first polyol(s) and the first catalyst. That is to say, the prepolymer obtained is not isolated or purified from this mixture, and thus the mixture comprising the prepolymer and the first catalyst (as well as residual polyol and isophorone diisocyanate) corresponds to the NCO component.

According to other embodiments, the urethane prepolymer is part of the NCO component of the composition.

Optionally, one or more additives may be added to the NCO component. These additives may be selected from plasticizers, solvents, pigments, adhesion promoters, moisture absorbers, UV stabilizers (or antioxidants), molecular sieves, fluorescent materials, rheological additives, and mixtures thereof.

The urethane prepolymer may be present in a content ranging from 60 to 100%, and preferably from 70 to 99%, relative to the total weight of the NCO component.

The additives may be present in a content of from 0 to 10%, and preferably from 0 to 2%, relative to the weight of the NCO component of the composition.

The OH component of the composition comprises the second polyol(s) and the second catalyst as described above.

According to some embodiments, just one second polyol is present in the OH component.

According to other embodiments, two or more second polyols (for example two, three, four or five polyols) are present in the OH component.

The second polyol(s) may be present in a content of from 60 to 100%, and preferably from 70 to 99%, relative to the total weight of the OH component.

According to some embodiments, just one second catalyst is present in the OH component.

According to other embodiments, two or more second catalysts (for example two) are present in the OH component.

The second catalyst may be present in a content of from 100 to 2000 ppm, and preferably from 200 to 800 ppm, relative to the weight of the OH component.

The OH component according to the invention may also comprise additives that may be present in the NCO component, such as plasticizers, solvents, pigments, adhesion promoters, moisture absorbers, UV stabilizers (or antioxidants), fluorescent materials, rheological additives, and mixtures thereof.

The additives may be present in a content of from 0 to 10%, and preferably from 0 to 2%, relative to the weight of the OH component of the composition.

The NCO component and the OH component of the two-component composition can preferably remain separate until the composition is used.

### Use of the Composition

The two-component composition of the invention may be prepared by mixing the NCO component of the composition with the OH component. During this mixing, the hydroxyl groups present on the second polyol can react (in the presence of the second catalyst) with the isocyanate termini of the urethane prepolymer to form the polyurethane adhesive.

The NCO component may be mixed with the OH component in an NCO/OH molar ratio ranging from 1.5 to 2.5, and preferably from 1.7 to 2.0.

The two-component composition can be used for the treatment of substrates such as paper, a metal such as aluminum, polyethylene (PE), polypropylene (PP), a copolymer based on ethylene and propylene, polyamide (PA), polyethylene terephthalate (PET), or even an ethylene-based copolymer such as a maleic anhydride graft copolymer, a copolymer of ethylene and vinyl acetate (EVA), a copolymer of ethylene and vinyl alcohol (EVOH), a copolymer of ethylene and an alkyl acrylate such as methyl acrylate (EMA) or butyl acrylate (EBA), polystyrene (PS), polyvinyl chloride (PVC), polyvinylidene fluoride (PVDF), a polymer or copolymer of lactic acid (PLA), or a polyhydroxyalkanoate (PHA). Also possible is a thin layer consisting of a thermoplastic polymer, preferably of PET, PE, and PP, covered with a layer of less than 1 μm of aluminum, alumina or silica.

The OH component of the composition is mixed with the OH component before coating the two-component composition (mixture of NCO and OH components) onto the surface of a substrate.

The NCO component may be mixed with the OH component at room temperature, for example at a temperature of from 15 to 60° C., and preferably from 23 to 50° C.

The coating of the two-component composition onto the surface of the substrate at a temperature ranging from 23 to 50° C., and preferably ranging from 35 to 40° C., may then be carried out.

The two-component composition can form a continuous layer on the surface of the substrate. This layer may have a thickness of from 1 μm to 25 μm, and preferably from 1 μm to 10 μm, and more preferably from 1 μm to 5 μm.

The two-component composition of the invention can be used as an adhesive composition so as to bond two substrates together. Thus, after crosslinking, the composition can form an adhesive layer holding two substrates fixed together. More particularly, after coating the two-component composition onto the surface of a substrate, the surface of an additional substrate can be contacted with the coated surface so as to bond the two substrates. According to some embodiments, the contacting of the additional substrate with the coated surface, the assembly may be placed under a heating press so as to accelerate the bonding of the two substrates together. The temperature of this press may be for example from 60 to 110° C., and preferably from 80 to 100° C.

The articles produced after application of the composition of the invention thus comprise at least one surface coated with the two-component composition. This is an internal surface of the article, that is to say a surface of the article that is in contact with, for example, another surface of the article, the two-component composition being located between these two surfaces.

According to some embodiments, the article produced may comprise more than two layers (or substrates), for example three or four layers (or substrates), these layers being fixed together with the two-component composition of the invention.

The two-component composition of the invention can therefore be used for preparing multilayer films for the production of flexible packaging. This type of film can be used for producing a diverse range of flexible packagings that are shaped and then closed (after the step of packaging of the product intended for the consumer) by heat-sealing (heat-welding) techniques.

According to preferred embodiments, these films are used for producing flexible packaging intended for sterilization treatments, such as the sterilization of food products packaged in said flexible packaging.

### EXAMPLES

The following examples illustrate the invention without limiting it.

The following compounds were used in the context of the examples:
Vestanat IPDI: isophorone diisocyanate sold by Evonik, having a molar weight of 222.6 g/mol and a % NCO content of between 37.5 and 37.8%;
Voranol® 1010L: polypropylene glycol sold by Dow, having a number-average molecular weight of between 984 and 1058 g/mol and a hydroxyl value (OH value) of between 106 and 114 mg KOH/g,
Voranol® CP450: polypropylene glycol triol sold by Dow, having a number-average molecular weight of between 425 and 455 g/mol and a hydroxyl value (OH value) of between 370 and 396 mg KOH/g,
Dekatol® 3008: aliphatic polyester diol sold by Bostik, having a number-average molecular weight of between 967 and 1039 g/mol and a hydroxyl value (OH value) of between 108 and 116 mg KOH/g,
MTBD: 7-methyl-1,5,7-triazabicyclo[4,4,0]dec-5-ene (CAS No. 84030-20-6);
DABCO: 1,4-diazabicyclo[2.2.2]octane (CAS No. 280-57-9);
TIB KAT® 216: dioctyltin dilaurate sold by TIB Chemicals.

### Example 1

The regioselectivity during the formation of the urethane prepolymer was examined using various catalysts.

Thus, 62.4 g of Vestanat IPDI was contacted with a mixture of 29.8 g of Voranol 1010L and 8.1 g of Voranol CP450 and 10 ppm of phosphoric acid (to neutralize any traces of catalyst present in the polyols) at a temperature of between 75 and 78° C., and with the various catalysts shown in the table below until the theoretical % NCO content of 18.6% was reached. This theoretical ratio is determined by calculation based on the composition of the reaction medium and the functionality of the starting materials used.

The NCO/OH ratio is 4.9.

The ratio r was calculated using the method detailed in the description.

The ratio r corresponds to the regioselectivity in respect of an isocyanate group attached to a primary carbon atom over an isocyanate group attached to a secondary carbon atom, which is calculated according to the method described above. The ratio r is greater than 0 when the catalyst used favors the reaction of isocyanate groups attached to a primary carbon atom (C1) and the ratio r is less than 0 when the catalyst favors the reaction of isocyanate groups attached to a secondary carbon atom (C2). The catalyst becomes less regioselective as the ratio r gets closer to 0.

The catalyst concentrations were adjusted so as to obtain a reaction similar to that obtained when dioctyltin is used as catalyst.

| | | Concentration | |
|---|---|---|---|
| Entry | Catalyst | (ppm) | Ratio r |
| 1 | — | — | −0.19 |
| 2 | DOTL | 600 | −0.85 |
| 3 | Fe(OTf)₂ | 240 | −0.68 |
| 4 | Co(acac)₂ | 42 | −0.69 |
| 5 | Zr(acac)₄ | 390 | −0.50 |
| 6 | TBO•HCl | 462 | −0.30 |
| 7 | TBD | 440 | −0.09 |
| 8 | BEMP | 2200 | −0.10 |
| 9 | DBN | 495 | −0.14 |
| 10 | DBU | 600 | 0.06 |
| 11 | DABCO | 450 | 0.21 |
| 12 | MTBO | 392 | 0.29 |
| 13 | TMG | 2300 | 0.32 |
| 14 | BTMG | 3500 | 0.40 |
| 15 | TBD⁻Na⁺ | 375 | 0.45 |
| 16 | TBO⁻Na⁺ | 442 | 0.47 |
| 17 | MTBD | 480 | 0.50 |
| 18 | Bn-TBD | 720 | 0.52 |

DOTL: dioctyltin dilaurate
Co(acac)₂: cobalt(II) acetylacetonate
Zr(acac)₄: zirconium(IV) acetylacetonate
Fe(OTf)₂: iron (II) trifluoromethanesulfonate
BEMP: 2-tert-butylimino-2-diethylamino-1,3-dimethylperhydro-1,3,2-diazaphosphorine
DBN: 1,5-diazabicyclo[4.3.0]non-5-ene
DBU: 1,8-diazabicyclo[5.4.0]undec-7-ene
DABCO: 1,4-diazabicyclo[2.2.2]octane
TBD: 1,5,7-triazabicyclo[4.4.0]dec-5-ene
MTBD: 7-methyl-1,5,7-triazabicyclo[4.4.0]dec-5-ene
Bn-TBD: benzylated 1,5,7-triazabicyclo[4.4.0]dec-5-ene
TBO: 1,4,6-triazabicyclo[3.3.0]oct-4-ene
MTBO: N-methyl-1,4,6-triazabicyclo[3.3.0]oct-4-ene
TMG: 1,1,3,3-tetramethylguanidine
BTMG: 2-tert-butyl-1,1,3,3-tetramethylguanidine

According to the results in the table above, the reaction in the absence of catalyst (entry 1) makes it possible to obtain the reverse regioselectivity to that obtained with the catalysts of the formulas (I) and (II). This reverse regioselectivity is also obtained with metal catalysts (entries 2 to 5) as well as with protonated guanidine-type catalysts (entries 6 and 7), phosphazene-type catalysts (entry 8), and amidine-type catalysts (entry 9). Other catalysts of the amidine (entry 10) and tertiary amine (entry 11) types make it possible to obtain regioselectivity in the same direction as the catalysts of the formulas (I) and (II), albeit less pronounced than desired. Lastly, with the catalysts corresponding to the formulas (I) and (II) (entries 12 to 18) it is possible to obtain urethane prepolymer having a ratio r of greater than 0.25.

### Example 2

The regioselectivity during the formation of the urethane prepolymer was examined using various catalysts.

Thus, 23.3 g of Vestanat IPDI was contacted with a mixture of 29.8 g of Voranol 1010L and 8.1 g of Voranol CP450 and 10 ppm of phosphoric acid (to neutralize any traces of catalyst present in the polyols) at a temperature of between 75 and 78° C., and with the various catalysts shown in the table below until the theoretical % NCO content of 6.4% was reached. This theoretical ratio is determined by calculation based on the composition of the reaction medium and the functionality of the starting materials used.

The NCO/OH ratio is 1.83.

As in example 1, the ratio r was calculated using the above method. The ratio r is greater than 0 when the catalyst used favors the reaction of isocyanate groups attached to a primary carbon atom (C1) and the ratio r is less than 0 when the catalyst favors the reaction of isocyanate groups attached to a secondary carbon atom (C2). The catalyst becomes less regioselective as the ratio r gets closer to 0.

| | | Concentration | |
|---|---|---|---|
| Entry | Catalyst | (ppm) | Ratio r |
| 1 | — | — | −0.25 |
| 2 | DOTL | 60 | −0.67 |
| 3 | Ti(acac)₂OiPr₂ | 70 | −0.60 |
| 4 | Zinc neodecanoate | 240 | −0.57 |
| 5 | Bismuth neodecanoate | 58 | −0.49 |
| 6 | DABCO | 450 | 0.05 |
| 7 | MTBD | 480 | 0.37 |
| 8 | BTMG | 3500 | 0.21 |

Ti(acac)₂OiPr₂: titanium diisopropoxide bis(acetylacetonate)

According to the results in the table above, the reaction in the absence of catalyst (entry 1) makes it possible to obtain the reverse regioselectivity to that obtained with the catalysts of the formulas (I) and (II). This reverse regioselectivity is also obtained with metal catalysts (entries 2 to 5). The tertiary amine catalyst DABCO (entry 6) makes it possible to obtain regioselectivity in the same direction as the catalysts of the formulas (I) and (II), albeit less pronounced than desired. Lastly, with the catalysts corresponding to the formulas (I) and (II) (entries 7 and 8) it is possible to obtain urethane prepolymer having a ratio r of greater than 0.2.

### Example 3

Three two-component compositions (A to C) were prepared by mixing an NCO component with an OH component. A is a composition according to the invention, whereas B and C are comparative compositions.

The NCO and OH components were prepared in an amount of 100 g each.

The NCO component of each composition was prepared by mixing the components at a temperature of 75 to 78° C. for a period of 2 to 3 hours for the NCO component of composition A (catalyzed by MTBD), of 2 to 3 hours for the NCO component of composition C (catalyzed by DOTL), and 32 hours for the NCO component of composition B (catalyzed by DABCO). MTBD is here representative of the first catalyst according to the invention. The NCO/OH ratio used for the synthesis of the NCO component of each composition is 1.7.

| | Composition A | Composition B | Composition C |
|---|---|---|---|
| | (NCO | (NCO | (NCO |
| | component) | component) | component) |
| Vestanat | 36.44% | 36.46% | 36.44% |
| IPDI | | | |
| Voranol ® | 49.92% | 49.94% | 49.92% |
| 1010L | | | |
| Voranol ® | 13.59% | 13.59% | 13.59% |
| CP450 | | | |
| MTBD | 0.048% | — | — |
| DABCO | — | 0.0060% | — |
| DOTL | — | — | 0.0450% |
| Total | 100% | 100% | 100% |
| % NCO | 5.58% | 5.63% | 5.56% |

The % NCO is measured using standard NF EN 1242.

| | Composition A | Composition B | Composition C |
|---|---|---|---|
| | (OH component) | (OH component) | (OH component) |
| Decatol ® | 74.24% | 74.24% | 74.24% |
| 3008 | | | |
| Voranol ® | 25.70% | 25.70% | 25.70% |
| CP450 | | | |
| DOTL | 0.06% | 0.06% | 0.06% |
| Total | 100% | 100% | 100% |
| OH value | 5.48% | 5.48% | 5.48% |
| (mg KOH/g) | | | |

The OH value (hydroxyl value) is measured using the ASTM E1899-08 standard.

The NCO and OH components of compositions A, B, and C were mixed in an NCO/OH molar ratio of 1.86.

Compositions A, B and C were then used (grammage of 2.5 g/m²) to produce PET-ALU (20 μm, =12 μm PET+8 μm aluminum)/adhesive composition (2.5 μm)/PE (50 μm) multilayer films and these films were then used to measure the crosslinking kinetics at 23° C. of the adhesive composition between the PET-ALU and PE layers over 18 days. The degree of crosslinking of the adhesive compositions between the two PET-ALU and PE films was measured by infrared spectrometry by monitoring the disappearance of the NCO functions on the adhesive film after delamination of samples taken each day from the three multilayer films.

| | Composition A | Composition B | Composition C |
|---|---|---|---|
| | (crosslinking rate) | (crosslinking rate) | (crosslinking rate) |
| Cat. 1/Cat. 2 | MTBD/DOTL | DABCO/DOTL | DOTL/DOTL |
| 10 days | 90% | 60% | 80% |
| 15 days | 95% | 85% | 90% |
| 18 days | 100% | 90% | 97% |

Cat. 1: first catalyst
Cat. 2: second catalyst

It is found that the Cat. 1/Cat. 2 =MTBD/DOTL combination of the invention permits a significant improvement in the crosslinking kinetics of composition A compared to comparative compositions B and C, with a degree of crosslinking greater than or equal to 90% at 10 days.

1. A method for preparing a polyurethane polymer, comprising
(A) contacting of at least one isophorone diisocyanate (IPDI) monomer with at least one first polyol in the presence of at least one first catalyst to form a urethane prepolymer;
(B) contacting of the urethane prepolymer with at least one second polyol in the presence of at least one second catalyst to form the polyurethane polymer;
wherein:
the first catalyst is selected from a catalyst of the general formula (I) or a catalyst of the general formula (II): 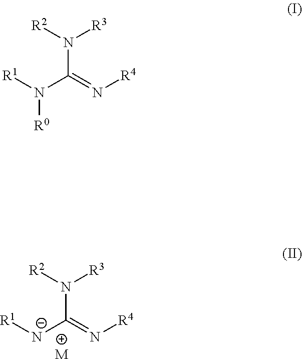
wherein:
R⁰ is a group containing from 1 to 10 carbon atoms, selected from an alkyl group, either linear or branched, or a cycloalkyl or arylalkyl group,
R¹, R², and R³ each independently represent a group containing from 1 to 10 carbon atoms, selected from an alkyl group, either linear or branched, or a cycloalkyl or arylalkyl group,
R⁴ represents a hydrogen atom or a group containing from 1 to 10 carbon atoms, selected from an alkyl group, either linear or branched, or a cycloalkyl or arylalkyl group,
at least two of R¹, R², R³, and R⁴ being optionally elements of a ring, and
M⁺ represents a monovalent cation; and
the second catalyst is an (organic)metallic catalyst;
or wherein:
the first catalyst is an (organic)metallic catalyst; and
the second catalyst is selected from a catalyst of the general formula (I) or a catalyst of the general formula (II).

2. The method as claimed in claim 1, wherein the first catalyst is selected from a catalyst of the general formula (I) or a catalyst of the general formula (II) and the second catalyst is an (organic)metallic catalyst.

3. The method as claimed in claim 1 or 2, wherein the first and/or the second polyol is selected from polyether polyols, polyester polyols, and mixtures thereof, and preferably the first and/or the second polyol comprises a polypropylene glycol.

4. The method as claimed in one of claims 1 to 3, wherein the second polyol is the same as the first polyol.

5. The method as claimed in one of claims 1 to 4, wherein M⁺ represents a Na⁺ cation.

6. The method as claimed in one of claims 1 to 5, wherein R⁰ is selected from a methyl group or a benzyl group.

7. The method as claimed in one of claims 1 to 6, wherein R¹ and R² or R¹ and R⁴ are elements of a ring.

8. The method as claimed in one of claims 1 to 6, wherein R¹ and R² are elements of a first ring and R³ and R⁴ are elements of a second ring.

9. The method as claimed in one of claims 1 to 8, wherein the (organic)metallic catalyst is selected from a tin catalyst, a zinc catalyst, a bismuth catalyst, a titanium catalyst, an iron catalyst, a copper catalyst, a zirconium catalyst, an aluminum catalyst, and combinations thereof, and the (organic)metallic catalyst is preferably selected from a zinc catalyst, a bismuth catalyst, a titanium catalyst, an iron catalyst, a copper catalyst, an aluminum catalyst, and a zirconium catalyst.

10. The method as claimed in one of claims 1 to 9, wherein, in the step of contacting at least one isophorone diisocyanate (IPDI) monomer with at least one first polyol, the NCO/OH molar ratio is between 1.5 and 5, preferably between 1.5 and 4, preferably between 1.5 and 3, and more preferably between 1.5 and 2.

11. A two-component composition for preparing a polyurethane polymer according to the method as claimed in one of claims 1 to 10, the composition comprising:
an NCO component comprising the urethane prepolymer prepared by step (A) of the method;
and an OH component comprising at least a second polyol and the second catalyst.

12. The composition as claimed in claim 11, wherein the NCO component also comprises one or more additives selected from plasticizers, solvents, pigments, adhesion promoters, moisture absorbers, UV stabilizers (or antioxidants), fluorescent materials, rheological additives, and mixtures thereof.

13. The composition as claimed in one of claim 11 or 12, wherein the NCO/OH molar ratio of the NCO component to the OH component is from 1.5 to 2.5, and preferably from 1.7 to 2.0.

14. The use of the composition as claimed in one of claims 11 to 13 as an adhesive for bonding two substrates together.

15. An article comprising at least one layer obtained by crosslinking of the composition as claimed in one of claims 11 to 13.

16. A method for preparing the article as claimed in claim 15, comprising:
mixing of the NCO component with the OH component of the composition;
coating of this mixture onto the surface of a substrate; and
contacting of this surface with the surface of an additional substrate.
